(19) United States
(12) Patent Application Publication
(10) Pub. No.: US 2024/0242235 A1
(43) Pub. Date: Jul. 18, 2024

(54) SYSTEMS, METHODS AND APPARATUS FOR HIERARCHICAL FORECASTING

(71) Applicant: Kinaxis Inc., Ottawa (CA)

(72) Inventor: Behrouz Haji SOLEIMANI, Ottawa (CA)

(21) Appl. No.: 18/623,557

(22) Filed: Apr. 1, 2024

Related U.S. Application Data
(63) Continuation-in-part of application No. 16/805,246, filed on Feb. 28, 2020.
(60) Provisional application No. 63/493,464, filed on Mar. 31, 2023.

(51) Int. Cl. G06Q 30/0202

(52) U.S. Cl. CPC G06Q 30/0202

(57) ABSTRACT

Systems and methods for reconciling a forecast within a multi-level hierarchy, comprising a pre-processing module and a forecast reconciliation module. The pre-processing module reconstructs the structure of the hierarchy and captures the relationship between the nodes of the multi-level hierarchy in a summation matrix S. The forecast reconciliation matrix uses S, a weight matrix W (that reflects a weighting scheme between the nodes) and a base forecast to optimize the overall forecast error using a least squares procedure. The reconciled forecast has a zero consistency error.

This application is a continuation-in-part of U.S. Ser. No. 16/805,246 filed Feb. 28, 2020; and also claims priority on U.S. Ser. No. 63/493,464 filed Mar. 31, 2023, the entirety of which is incorporated by reference herein.

### BACKGROUND

Companies with complex supply chains have a vital interest in predicting their demand for each product a few months in the future. Having an accurate estimate of the demand helps companies plan their manufacturing ahead of time and produce just enough products to avoid overstock and understock. There are inherent hierarchies in the supply chain data that can be used and exploited to arrive at better predictions and forecasting of demand. For instance, products are ordered by different customers and the demand for each product-customer combination can be forecasted separately and aggregated into the total demand of products. Or alternatively the total demand of a product can be forecasted directly from the aggregated historical demands. In any case, there is an aggregation constraint that the sum of demands of a product from different customers should match the total demand of a product. However, if the future demand at different levels of the hierarchy is predicted separately, forecasts will not add up correctly. For this reason, most companies only forecast their demands at the most disaggregated level of a hierarchy (e.g. for each product-customer combination).

Hierarchies can be defined in many different ways and can have many levels. For instance, a hierarchy can be based on geographical regions—such that the total demand of a product equals the sum of demands from different countries and the demand of a given country equals the sum of demands from different regions/districts of that country. Another way a hierarchy can be defined is based on a product family. For instance, the total demand for televisions in an electronics company equals the sum of demand for different sizes or models of televisions. Hierarchies can also be defined based on time dimensions. For example, the sum of weekly demands should match monthly or quarterly demands.

Due to the complicated nature of the problem, most companies predict their demand at only one level of a hierarchy. It is usually the level that a company believes will be most accurate or makes the most sense for the company. Nonetheless, each individual forecast has an associated error. Adding the individual forecasts within the hierarchy leads to a cumulative error in the overall forecast, which can be quite large.

In the realm of time-series forecasting, Hyndman has examined optimally reconciling forecasts in a temporal hierarchies, including optimal forecast reconciliation for hierarchical and grouped time series through trace minimization. However, this study does not readily translate to the management of forecasts of supply chains.

Therefore, there is a need to improve the overall forecasting activity by minimizing the overall forecasting error. In addition, there is a need to provide forecast reconciliation for non-time series hierarchies, such as, for example, supply chains.

### BRIEF SUMMARY

Disclosed herein are systems and methods that can take into account forecasting at different levels of a hierarchy and improve the overall forecasting by reducing the overall forecasting error of the hierarchy. In some embodiments, information about the relationships within the hierarchy is used to take inconsistent forecasts of different levels as input, and reconcile the forecasts to become completely consistent so that they add up correctly. In addition, the overall accuracy of forecasts across the entire hierarchy is improved.

In the field of supply chain planning, the more accurate the forecast for demand, the less waste of manufacturing resources, inventory infrastructure and transportation costs, thus leading to an reduction in emissions. Improved demand forecasting results in and overall change of the manufacture of raw materials and transportation of goods in response to new demand forecast.

In one aspect, a computer-implemented method is provided that includes receiving, by a processor, data related to two or more hierarchies, generating, by the processor, a multi-level hierarchy based on the data, the two or more hierarchies and a summation matrix related to a structure of the multi-level hierarchy, truncating, by the processor, the multi-level hierarchy such that the summation matrix is reduced to a maximum size of order (100000×100000), receiving, by the processor, a base forecast of the hierarchy, generating, by the processor, a weight matrix, the weight matrix reflecting a weight for each node of the multi-level hierarchy, and generating, by the processor, a reconciled forecast based on a projection of the base forecast onto a bottom level of the multi-level hierarchy, subject to a constraint on each node of the bottom level of the multi-level hierarchy.

The computer-implemented method may also include where the base forecast is generated from a non-linear Machine Learning model. The computer-implemented method may also include where truncation of the summation matrix is based on one or more threshold conditions applied to the data. The computer-implemented method may also include where the reconciled forecast is based on a non-negative least squares optimization technique. The computer-implemented method may also include where the reconciled forecast is based on an iterative optimization in which each node of the bottom level forecast is bound within a respective range. The computer-implemented method may also include where each entry of the weight matrix is related to one or more metrics of the multi-level hierarchy. The computer-implemented method may also include where each entry of the weight matrix is related to a forecast error of each node of the multi-level hierarchy, the forecast error obtained from a validation set used in training a non-linear machine learning model used for generating the base forecast.

In one aspect, a non-transitory computer-readable storage medium is provided, the computer-readable storage medium including instructions that when executed by a computer, cause the computer to receive data related to two or more hierarchies, generate a multi-level hierarchy based on the data, the two or more hierarchies and a summation matrix related to a structure of the multi-level hierarchy, truncate the multi-level hierarch such that the summation matrix is reduced to a maximum size of order (100000×100000), receive a base forecast of the hierarchy, generate a weight matrix, the weight matrix reflecting a weight for each node of the multi-level hierarchy, and generate a reconciled forecast based on a projection of the base forecast onto a bottom level of the multi-level hierarchy, subject to a constraint on each node of the bottom level of the multi-level hierarchy.

The computing apparatus may also include where the base forecast is generated from a non-linear Machine Learning model. The computing apparatus may also include where truncation of the summation matrix is based on one or more threshold conditions applied to the data. The computing apparatus may also include where the reconciled forecast is based on a non-negative least squares optimization technique. The computing apparatus may also include where the reconciled forecast is based on an iterative optimization in which each node of the bottom level forecast is bound within a respective range. The computing apparatus may also include where each entry of the weight matrix is related to one or more metrics of the multi-level hierarchy. The computing apparatus may also include where each entry of the weight matrix is related to a forecast error of each node of the multi-level hierarchy, the forecast error obtained from a validation set used in training a non-linear machine learning model used for generating the base forecast. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to receive data related to two or more hierarchies, generate a multi-level hierarchy based on the data, the two or more hierarchies and a summation matrix related to a structure of the multi-level hierarchy, generate, a weight matrix, the weight matrix reflecting a weight for each node of the multi-level hierarchy, truncate the multi-level hierarch such that the summation matrix is reduced to a maximum size of order (10×10⁵), and generate a reconciled forecast based on a projection of the base forecast onto a bottom level of the multi-level hierarchy, subject to a constraint on each node of the bottom level of the multi-level hierarchy.

The computer-readable storage medium may also include where the base forecast is generated from a non-linear Machine Learning model. The computer-readable storage medium may also include where truncation of the summation matrix is based on one or more threshold conditions applied to the data. The computer-readable storage medium may also include where the reconciled forecast is based on a non-negative least squares optimization technique. The computer-readable storage medium may also include where the reconciled forecast is based on an iterative optimization in which each node of the bottom level forecast is bound within a respective range. The computer-readable storage medium may also include where each entry of the weight matrix is related to one or more metrics of the multi-level hierarchy. The computer-readable storage medium may also include where each entry of the weight matrix is related to a forecast error of each node of the multi-level hierarchy, the forecast error obtained from a validation set used in training a non-linear machine learning model used for generating the base forecast. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system architecture in accordance with one embodiment.

FIG. 2 illustrates a block diagram in accordance with one embodiment.

FIG. 3 illustrates an example of a hierarchy in accordance with one embodiment.

FIG. 4 illustrates a hierarchy forecast in accordance with one embodiment.

FIG. 5 illustrates a hierarchy forecast in accordance with one embodiment.

FIG. 6 illustrates a table of symbols.

FIG. 7 illustrates a forecast reconciliation framework in accordance with one embodiment.

FIG. 8 illustrates evaluation of a projection matrix in accordance with one embodiment.

FIG. 9 illustrates evaluation of a projection matrix in accordance with one embodiment.

FIG. 10 illustrates a flow chart in accordance with one embodiment.

FIG. 11 illustrates a flow chart in accordance with one embodiment.

FIG. 12 illustrates a flow chart of a forecast reconciliation in accordance with one embodiment.

FIG. 13 illustrates a comparison of base forecast errors and reconciled forecast errors in accordance with one embodiment.

FIG. 14 illustrates two graphs of demand versus date in accordance with one embodiment.

FIG. 15 illustrates an aspect of the subject matter in accordance with one embodiment.

FIG. 16 illustrates an aspect of the subject matter in accordance with one embodiment.

FIG. 17 illustrates an aspect of the subject matter in accordance with one embodiment.

FIG. 18 illustrates an aspect of the subject matter in accordance with one embodiment.

FIG. 19 illustrates an aspect of the subject matter in accordance with one embodiment.

FIG. 20 illustrates an aspect of the subject matter in accordance with one embodiment.

FIG. 21 illustrates an aspect of the subject matter in accordance with one embodiment.

FIG. 22 illustrates an aspect of the subject matter in accordance with one embodiment.

FIG. 23 illustrates an aspect of the subject matter in accordance with one embodiment.

FIG. 24 illustrates an aspect of the subject matter in accordance with one embodiment.

FIG. 25 illustrates an aspect of the subject matter in accordance with one embodiment.

### DETAILED DESCRIPTION

Disclosed herein are systems and method of hierarchical forecasting that reconcile forecasts and renders all forecasts consistent across an entire hierarchy, thereby solving the inconsistency problem encountered by previous attempts. Furthermore, these systems and methods use information from all levels of the hierarchy to reduce the overall error across the entire hierarchy.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

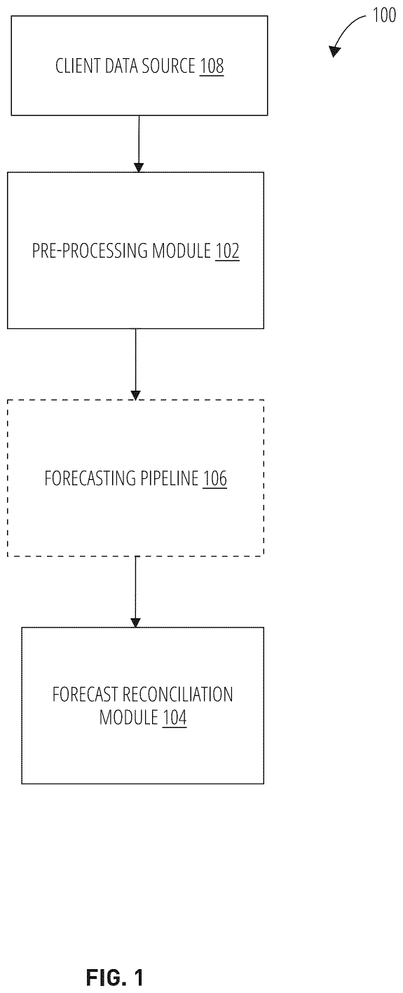

FIG. 1 illustrates a system architecture 100 in accordance with one embodiment.

In some embodiments, the hierarchical forecasting system comprises a pre-processing module 102 and a forecast reconciliation module 104. The two modules can be plugged in to any existing forecasting pipeline 106, thereby making any sets of forecasts consistent and with improved accuracy (by reducing the overall forecasting error). This enables companies to use existing tailored forecasting solutions in conjunction with the hierarchical forecasting system and method disclosed herein.

In some embodiments, forecasting pipeline 106 uses Machine Learning with algorithms such as Artificial Neural Networks, Gradient Boosted Decision Trees, Ensemble of different models, or any other non-linear Machine Learning algorithm, to generate forecasting results. In an embodiment, Gradient Boosted Decision Trees are used to generate forecasts.

Client data source 108 provides information about the structure of a hierarchy (from a client), such that the hierarchy can be reconstructed. In some embodiments, the pre-processing module 102 builds the hierarchy and relationships between nodes of the hierarchy, as well as data aggregation for higher levels of the hierarchy.

In some embodiments, the pre-processing module 102 removes nodes that have very small values (that is, less than a threshold value) or have the value zero. Such small quantities add very little value to the forecast reconciliation, yet make the structure more complex.

In some embodiments, the pre-processing module 102 can fill missing records based on sibling information. That is, pre-processing module 102 can exploit the hierarchy to fill in missing information.

In some embodiments, the pre-processing module 102 can extract rolling features (i.e. lag-based features) at all levels of the hierarchy. In some embodiments, such extraction can be accomplished using statistics of the rolling features of children in parents when aggregating data for higher levels.

The forecast reconciliation module 104 ensures that forecasts are consistent and have an overall reduced forecasting error. The forecast reconciliation module 104 comprises an optimization procedure that makes forecasts consistent and more accurate. In some embodiments, the optimization during forecast reconciliation can be constrained. For example, when forecasting a demand in a supply chain, a negative number should not be permitted in the forecast. In some embodiments, both unconstrained and constrained forms of forecast reconciliation can be configured by a user based on the business needs of the company.

In some embodiments, a generic weighting scheme can be used for the optimization. In some embodiments, the weighting scheme can assign an importance value to individual nodes during the optimization based on any business-specific importance values or metrics. In some embodiments, these metrics/values include cost of products, volume of orders, error rate of forecasts, etc. In such cases, the weighting scheme can be devised by the pre-processing module. In some embodiments, the weighting scheme can assign an importance value to the forecast error of each node. In such cases, the weighting scheme is devised following the forecasting pipeline 106, since the forecasting pipeline 106 provides the error estimates for each node in the hierarchy.

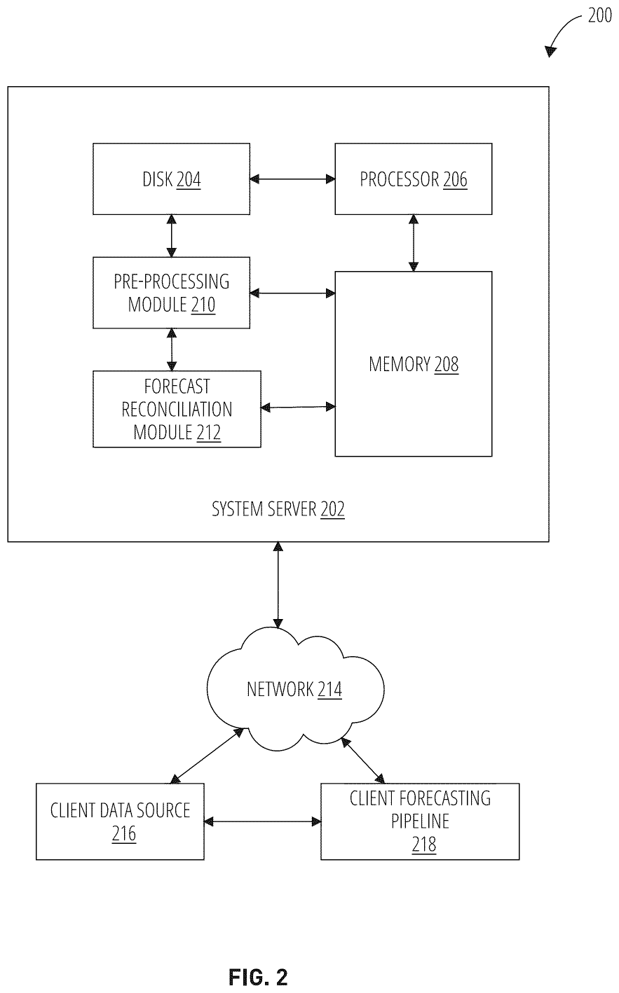

FIG. 2 illustrates a system 200 in accordance with one embodiment of a dynamic demand sensing system.

system 200 includes a system server 202, client data source 216 and client forecasting pipeline 218. System server 202 can also include a memory 208, a disk 204, a processor 206, a pre-processing module 210 and a forecast reconciliation module 212. While one processor 206 is shown, the system server 202 can comprise one or more processors. In some embodiments, memory 208 can be volatile memory, compared with disk 204 which can be non-volatile memory. In some embodiments, system server 202 can communicate with client data source 216 and client forecasting pipeline 218 via network 214.

system 200 can also include additional features and/or functionality. For example, system server 202 can also include additional storage (removable and/or non-removable) including, but not limited to, magnetic or optical disks or tape. Such additional storage is illustrated in FIG. 2 by memory 208 and disk 204. Storage media can include volatile and nonvolatile, removable and non-removable media implemented in any method or technology for storage of information such as computer-readable instructions, data structures, program modules or other data. Memory 208 and disk 204 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system server 202. Any such non-transitory computer-readable storage media can be part of system server 202.

Communication between system server 202, client data source 216 and client forecasting pipeline 218 via network 214 can be over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). Generally, communication between various components of system 200 may take place over hard-wired, cellular, Wi-Fi or Bluetooth networked components or the like. In some embodiments, one or more electronic devices of system 200 may include cloud-based features, such as cloud-based memory storage.

Client data source 216 may provide a variety of raw data from a client. It can comprise enough information to reconstruct a hierarchy—including the structure of the hierarchy and relationships between various nodes of the hierarchy.

Using network 214, system server 202 can retrieve data from client data source 216 and access client forecasting pipeline 218. The retrieved data can be saved in memory 208 or disk 204. In some cases, system server 202 can also comprise a web server, and can format resources into a format suitable to be displayed on a web browser.

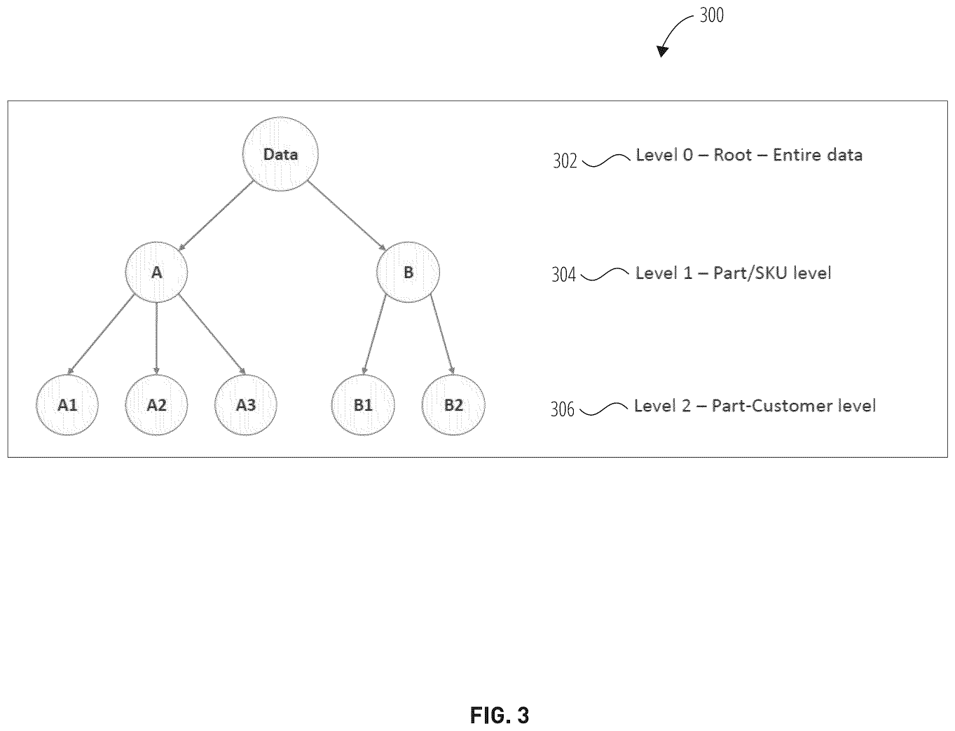

FIG. 3 illustrates an example of a hierarchy 300 in accordance with one embodiment. The example hierarchy 300 is a hierarchy of parts and customers, with three levels: Level 0 302 (the Root or entire data); Level 1 304 (Part/SKU level); and Level 2 306 (Part-Customer level). Eight nodes are labelled as: A1, A2, A3, B1, B2, A, B, Data). There are 5 nodes (A1, A2, A3, B1, B2) at Level 2 306; two nodes (A, B) at Level 1 304 and one node (Data) at Level 0 302. In an embodiment of a supply chain, the hierarchy can have multiple levels and thousands of nodes.

While hierarchy 300 illustrates a customer-parts hierarchy, there can be various forms of a hierarchy.

In a non-limiting example, the hierarchy may be a geographical hierarchy, where the different levels of the hierarchy represent different geographical regions. For example, the lowest level can represent major regions of a country; the mid-level can represent different countries; and the top-most level can represent the world total. For example, in a supply chain hierarchy, the sum of the forecast demand from every region (of country A) at nodes A1, A2 and A3 should equal the forecast demand (for country A) at node A. Similarly, the sum of the forecast demand from every region (of country B) at nodes B1 and B2 should equal the forecast demand (for country B) at node B. Finally, the sum of the forecast demand from country A at node A and country B at node B should equal the worldwide forecast demand at Level 0 302 (Data).

In a non-limiting example, the hierarchy may be a product hierarchy, where the different levels of the hierarchy represent different types (e.g. Size, make, model) of a product. The sum of the demand for different types/sizes of the product should match the total product demand.

In a non-limiting example, the hierarchy may be an event time-based hierarchy, where the different levels of the hierarchy represent different time periods of demand. The sum of weekly demands (Level 2 306) should match monthly/quarterly demands (Level 1 304), which in turn, should match a yearly demand (Level 0 302).

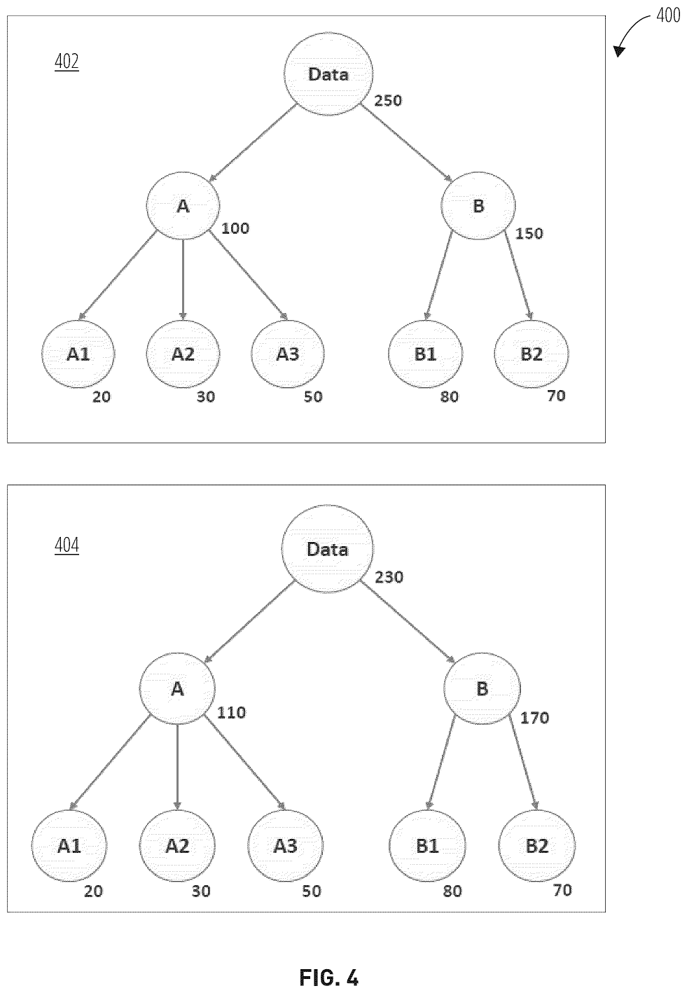

FIG. 4 illustrates a hierarchy forecast 400 in accordance with one embodiment.

An ideal forecast 402 is shown, in which the nodes have the following forecast values: A1=20, A2=30 and A3=50; B1=80 and B2=70; A=100; B=150; and Data=250. Note that in 202, A1+A2+A3=A; B1+B2=B; and A+B=Data. That is, the sum of all of the forecasts for one set of branches at one level equals the forecast for the node above; and the sum of all of the forecasts at one level equals the forecast for the level above.

However, in reality, the forecasts at different levels don't always add up, as forecasts at different levels are made independently of each other. Real forecast 404 illustrates this phenomena. For example, the sum of forecasts for nodes A1, A2 and A3 is: A1+A2+A3=100; whereas the forecast for node A is actually 110. There is a discrepancy of +10, i.e. A−(A1+A2+A3)=10. Similarly, the sum of forecasts for nodes B1 and B2 is: B1+B2=150; whereas the forecast for node B is actually 170. There is a discrepancy of +20, i.e. B−(B1+B2)=20. Furthermore, the sum of the forecast for nodes A and B is: A+B=280; whereas the forecast for Data is 230. There is a discrepancy of −50, i.e. Data—(A+B)=−50.

The discrepancy at each level is called the “consistency error”. This is different from the forecast error, which is the error associated with each forecast (i.e. at each node). For example, A1 has a forecast of 20. While not shown in FIG. 4, this forecast at A1 has an associated uncertainty; for example, A1=20±2. Each node has its own forecasting error, which is provided by an algorithm that formulates each forecast.

In the systems and methods of hierarchical forecasting disclosed herein, the forecasts at each level of the hierarchy are reconciled such that the consistency error is zero. An optimal forecast is obtained at the very bottom level (i.e., the most disaggregated level); these lowest-level optimal forecasts are added in order to calculate the higher-level forecasts, in accordance with a zero consistency error.

### Forecast Reconciliation

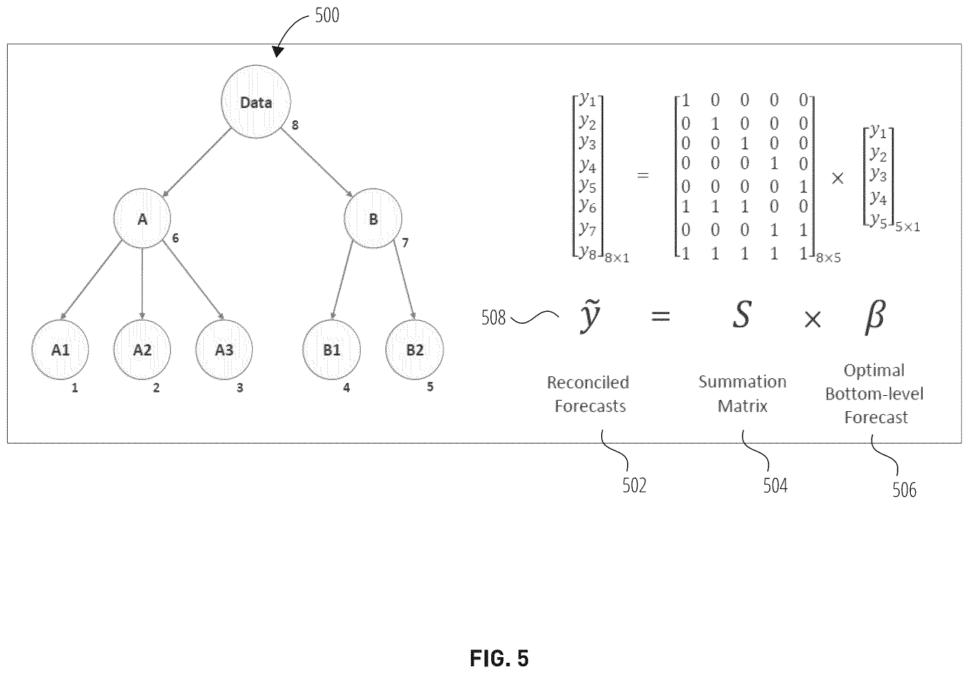

FIG. 5 illustrates a hierarchy forecast in accordance with one embodiment. The example hierarchy 500 has eight nodes (e.g. A1, A2, A3, B1, B2, A, B, Data) that are indexed from one to eight. Five nodes (A1, A2, A3, B1, B2) are at the lowest level of the hierarchy; two nodes (A, B) are at the mid-level and one node (Data) is at the highest level of the hierarchy. In some embodiments where the hierarchy represents a supply chain, the hierarchy can have multiple levels and thousands of nodes.

Since the consistency error is zero, the reconciled forecasts 502 (\tilde{γ}) of each of the eight nodes is the sum of the child forecast nodes below, with the bottom-level nodes having an optimal bottom-level forecast 506 (β). The relationship between the reconciled forecasts 502 (\tilde{γ}) and the optimal bottom-level forecast 506 (β) is given by equation 508 (or equation (1) below), in which summation matrix 504 (\tilde{γ}) is applied to the optimal bottom-level forecast 506 (β) to yield the reconciled forecasts 502 (\tilde{γ}). Summation matrix 504 (\tilde{γ}) is an 8×5 matrix for the example shown in hierarchy 500, while optimal bottom-level forecast 506 (β) is a 5×1 vector and the reconciled forecasts 502 (\tilde{γ}) is an 8×1 vector. That is:

$$\tilde{y} = S β \qquad ( 1 )$$

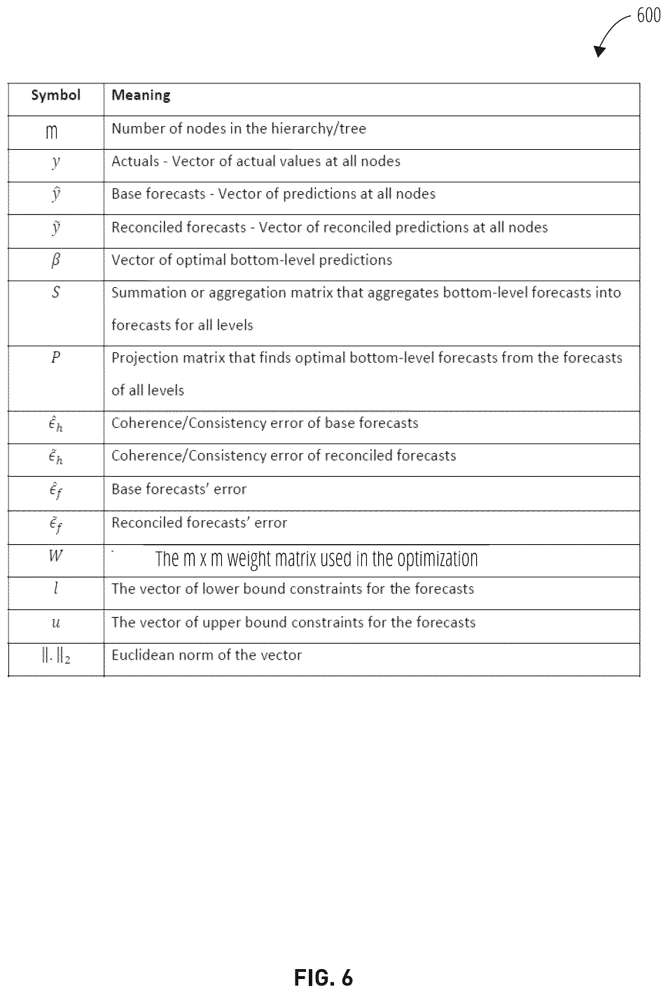

FIG. 6 illustrates a table of symbols 600 that summarizes the various entities used to describe forecast reconciliation in some embodiments.

The problem of finding the reconciled forecasts is now changed to finding the optimal bottom-level forecasts (β). In some embodiments, the bottom-level forecasts can be estimated by using a projection matrix that maps forecast from all levels to the bottom level. This way, all the forecasts at all levels are used to find the optimal projection to the bottom level:

$$β = P \hat{y} \qquad ( 2 )$$

In Eq. (3), \hat{γ} is a vector that represents the base forecasts (i.e. a vector of the forecasts generated by the forecasting pipeline 106 of FIG. 1 at all of the nodes in the hierarchy). Therefore, the problem of finding the optimal bottom-level forecasts 506 (β) is now changed to finding the optimal projection, P, which maps base forecasts (\hat{γ}) optimally to the bottom level of the hierarchy. Once the optimal projection P is obtained, the reconciled forecasts (\tilde{γ}) can be computed using the following formula:

$$\tilde{y} = SP \hat{y} \qquad ( 3 )$$

Using this formulation, the base forecasts (\hat{γ}) are first mapped to the bottom-level using the projection, P to give the optimal bottom-level forecasts (β), and then the bottom-level forecasts (β) are aggregated to all levels using the summation matrix S, defined in FIG. 5. The aggregation operation guarantees 100% consistency across the hierarchy since all the higher level forecasts are computed based on the bottom level.

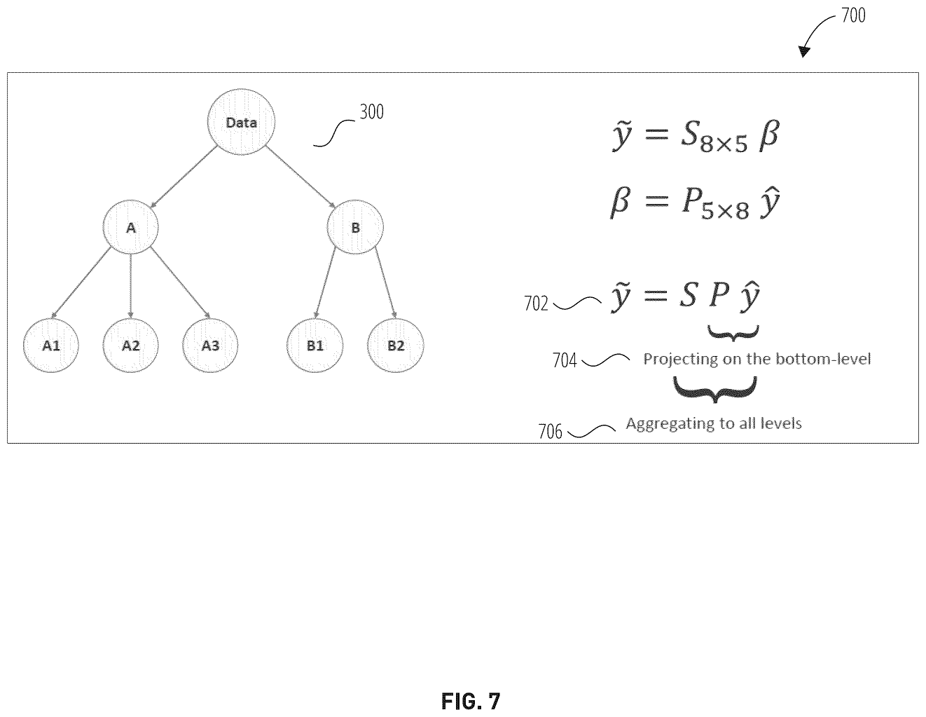

FIG. 7 illustrates a forecast reconciliation framework 700 in accordance with one embodiment, with reference to Eq. (1)—Eq. (3) above. In FIG. 7, Eq. (3) as represented by 702, is broken into two steps: a first step which is bottom-level projection 704 (that is, P\hat{γ}); and a second step which is aggregation to all levels 706 (that is, S applied to P\hat{γ}).

In order to solve Eq. (3) above, in closed form, the following approximation is made:

$$S β \approx \hat{y}$$

That is, in Equation (1), the reconciled forecasts (\tilde{γ}) (i.e. the vector of reconciled forecasts at all nodes) is replaced with the base forecasts (\hat{γ}) (i.e. the vector of forecasts at all nodes).

In order to solve for β, the transpose of S is applied to both sides of Eq (4):

$${S}^{T} S β = {S}^{T} \hat{y}$$

While S is not necessarily a square matrix, the product S^{T}S is, allowing for the isolation of β:

$$β = {( {S}^{T} S )}^{- 1} {S}^{T} \hat{y} \qquad ( 5 )$$

The above Eq. (5) represents solving a system of linear equations for the vector of optimal bottom-level forecasts (β) using an Ordinary Least Squares (OLS) algorithm.

With reference to Eq. (2), we see that, using the approximation of Eq. (4), the projection matrix P is found as follows:

$$P = {( {S}^{T} S )}^{- 1} {S}^{T} \qquad ( 6 )$$

The projection operation defined in P is a linear transformation, which means every bottom-level forecast in β will be a weighted linear combination of all forecasts. After computing the projection matrix P, any base forecasts can be projected to the bottom level and aggregated back upwards. This enables the algorithm to be used in conjunction with existing forecasting pipelines.

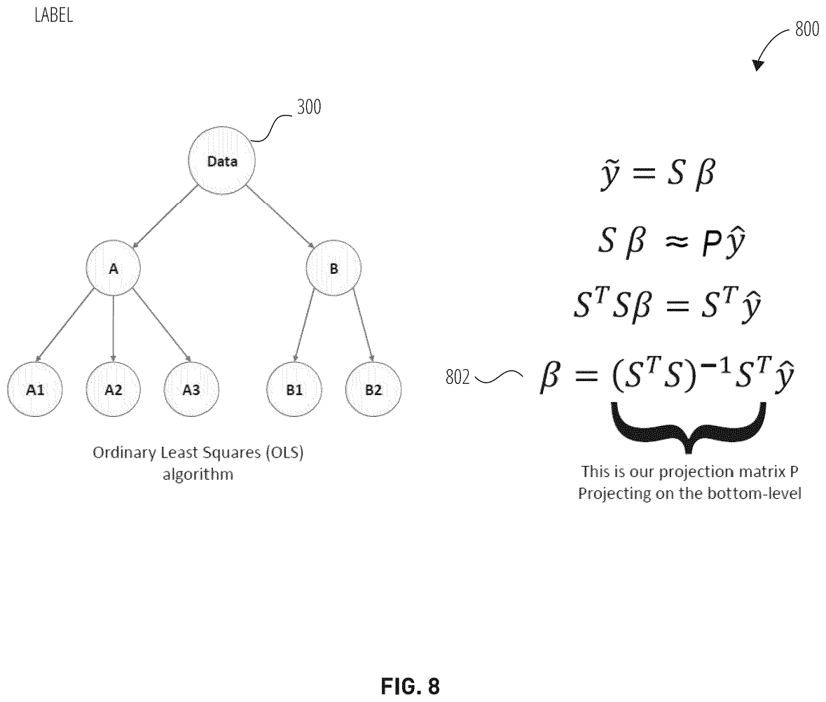

FIG. 8 illustrates evaluation of a projection matrix 800 in accordance with one embodiment, with reference to Eq. (4) to Eq. (6) above. The bottom-level forecast β is shown in 802 which represents Eq. (5), thereby identifying the projection matrix P.

### Generalized Forecast Reconciliation

The OLS solution (see Eq. (5)) can be generalized to a weighted optimization which can consider a weight for each of the nodes of the tree during the optimization. In this generalized form, the projection matrix P can be found using a Generalized Least Squares (GLS) technique:

$$P = {( {S}^{T} WS )}^{- 1} {S}^{T} W \qquad ( 6 )$$

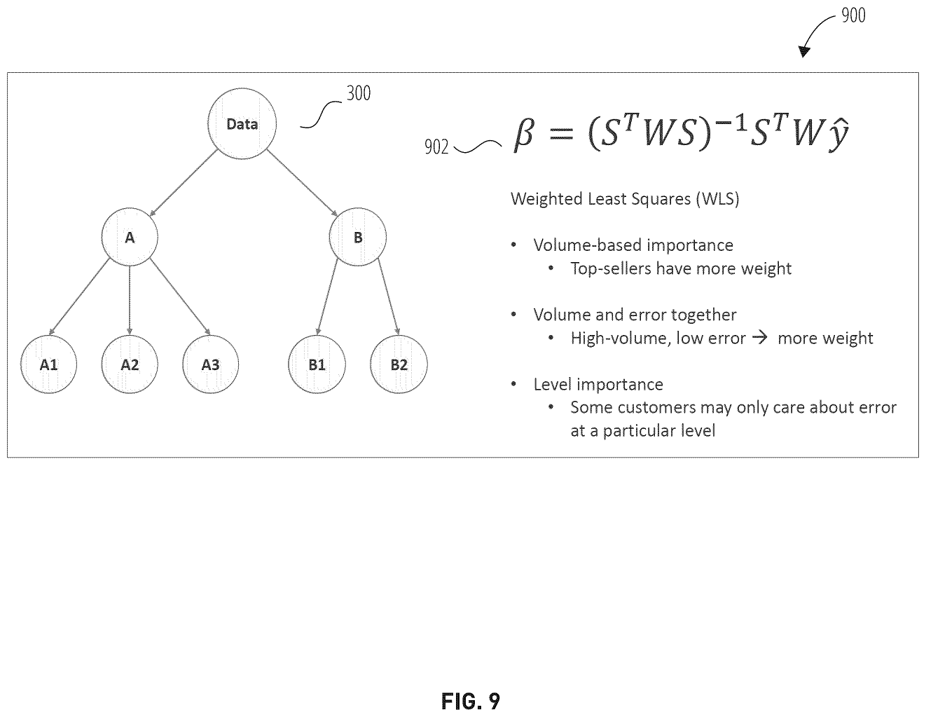

When W is diagonal, the GLS is referred to as Weighted Least Squares (WLS). Eq. (6) is illustrated in FIG. 9, where the equivalent of eq. (6) 902 is shown, along with examples of different embodiments of the weight matrix W. Note that Eq. (6) is general—the weight matrix W can be set to the identity matrix when no particular weighting scheme is used.

The hierarchy is built once and is defined by summation matrix S. In the example hierarchy 300, the weight matrix W is an 8×8 matrix. In some embodiments, W is a diagonal matrix (i.e. all the off-diagonal elements are 0 and only the diagonal elements—8 elements corresponding to 8 nodes—are non-zero). Examples can be inverse of error rate of base forecasts, volume of orders in each node, total cost/value of orders in each node, etc. The off-diagonal elements weight the relationship between nodes.

In some embodiments, the inverse of error rate of the base forecasts is used as diagonal entries of the weight matrix W. In such embodiments, the projection to the bottom level of the hierarchy is a Best Linear Unbiased Estimate (BLUE).

This weighting scheme can be extended to allow a customer to use any business-specific importance value or metric desired by the customer. In some embodiments, importance can be assigned to a node based on the volume of orders in that node. In some embodiments, importance can be assigned to a node based on the total cost of items in the node. In some embodiments, importance can be assigned to different levels of the hierarchy. As can be seen, importance can be assigned to any other metric.

These weights determine the importance of each item in the optimization when finding the projection. For example, if a first product is ordered ten times a second product, then the first product has more impact on the forecast reconciliation. In some embodiments, a combination of error rate and volume/cost is used, such that a top-selling product with low error rate has the greatest impact on the reconciliation.

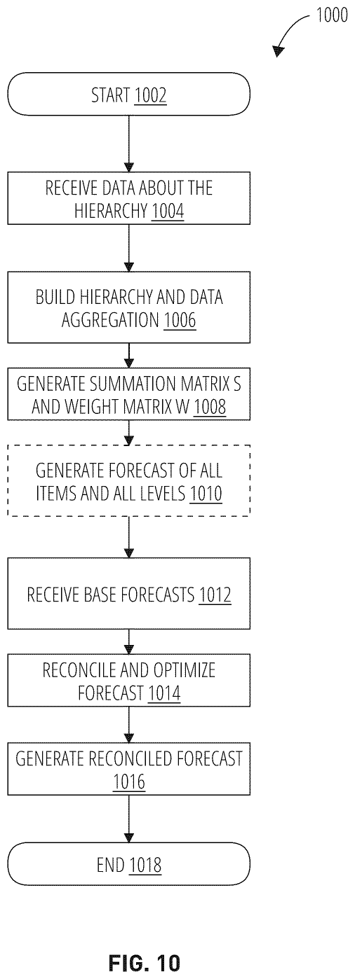

FIG. 10 illustrates a flow chart 1000 in accordance with one embodiment of hierarchical forecasting. At step 1004, the pre-processing module 102 (of FIG. 1) receives data that permits the construction of a hierarchy. For example, pre-processing module can receive records or tabular data with a set of key columns that correspond to hierarchy levels. At step 1006, the pre-processing module 102 builds the hierarchy and data aggregation and generates a summation matrix S related to the hierarchy at step 1008. In the embodiment shown in FIG. 10, the weight matrix W is also generated at step 1008. Here, the weight matrix W may be related to the metrics of each node in the hierarchy. This information can then be plugged into the existing forecasting pipeline 106 (of FIG. 1) that, at step 1010, generates a forecast of all items and all levels (i.e. a base forecast). At step 1012, the forecast reconciliation module 104 (of FIG. 1) receives the base forecasts, and at step 1014, reconciles and optimizes the forecast to generate a reconciled forecast at step 1016.

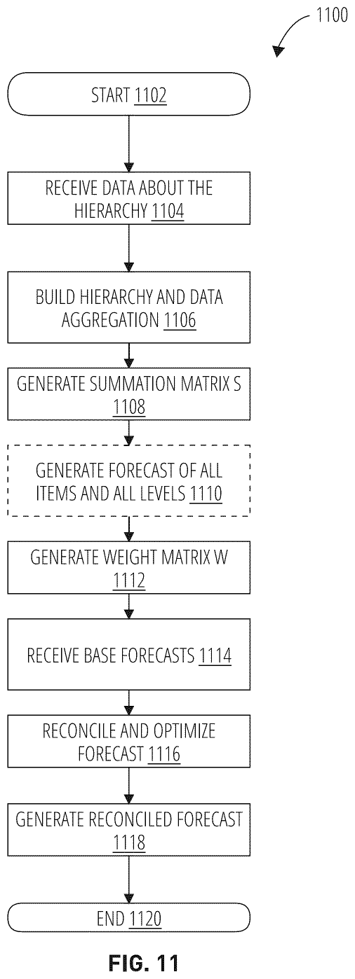

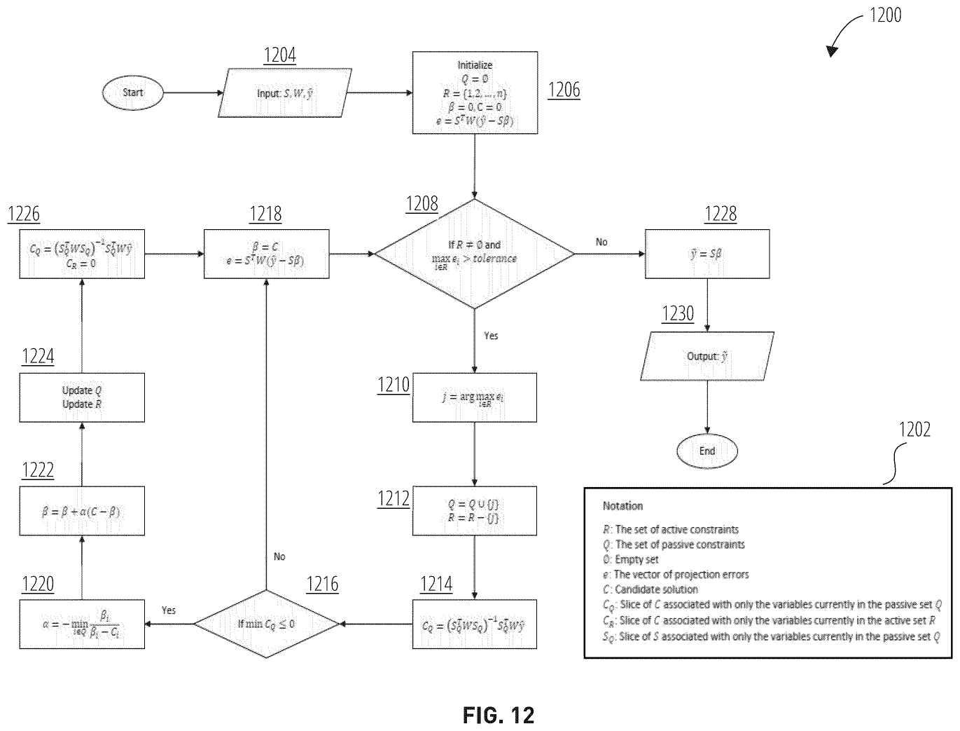

FIG. 11 illustrates a flow chart 1100 in accordance with one embodiment of hierarchical forecasting. At step 1104, the pre-processing module 102 (of FIG. 1) receives data that permits the construction of a hierarchy. For example, pre-processing module can receive records or tabular data with a set of key columns that correspond to hierarchy levels. At step 1106, the pre-processing module 102 builds the hierarchy and data aggregation and generates a summation matrix S related to the hierarchy at step 1108. This information can then be plugged into the existing forecasting pipeline 106 (of FIG. 1) that, at step 1110, generates a forecast of all items and all levels (i.e. a base forecast). In the embodiment shown in FIG. 12, the weight matrix W is generated at step 1112. Here, W can be related to the forecasting errors at each node, each of which is generated during step 1110. At step 1114, the forecast reconciliation module 104 (of FIG. 1) receives the base forecasts, and at step 1116, reconciles and optimizes the forecast to generate a reconciled forecast at step 1118.

### Constrained Forecast Reconciliation

As described above, the generalized least squares (GLS) optimization adjusts forecasts such that the overall forecast error is reduced and ensures that the reconciled forecasts add-up correctly (that is, the consistency error is zero). However, this results in some of the forecasts having a negative value. Yet there exist domain-specific constraints in different applications. For example, if demand of products is being forecasted, the reconciled forecasted demand cannot be negative. However, integration of such a constraint is not trivial or known to the optimization algorithm. In order to solve this non-trivial problem, non-negativity constraints are imposed during the optimization. In this modified approach, a Non-Negative Least Squares (NNLS) algorithm is used to find the optimal bottom-level reconciled forecasts β, given the constraints that they cannot be negative:

$$β = arg {min}_{β} {‖ S β - \hat{y} ‖}_{2} subject to β > 0 \qquad ( 7 )$$

This form of optimization differs from the weighted least squares technique in that it does not have a closed-form solution. The OLS and WLS both have closed form solutions which can be obtained directly by solving the equations (5) and (6), respectively. However, the constrained form of optimization requires iterative optimization and numerical solvers.

The NNLS in Equation (7) may be solved using an active set method in which the set of constraints that are active are maintained at any candidate solution. A constraint is called active if the candidate solution lies exactly on the boundary which means slight alterations in the solution may violate those constraints. The active set determines which constraints influence the final result of optimization. The solution found by the constrained optimization may not be the optimal answer in terms of having the minimum overall error, however, it guarantees that the solution satisfies all the constraints, and therefore, it is optimal in the feasible region of search space.

In some embodiments, any arbitrary form of inequality constraint for any node in the tree can be used. For instance, if a predicted quantity is constrained to be between a lower bound and an upper bound, a Bounded-Variable Least Squares (BVLS) optimization can be used:

$$β = arg {min}_{β} {‖ S β - \hat{y} ‖}_{2} subject to l < β < u \qquad ( 8 )$$

In some embodiments, each node in the hierarchy can have its own lower and upper bound constraint. Bounded-Variable Least Squares (BVLS) method is also an iterative optimization that requires numerical solvers. Similar to NNLS, BVLS also uses an active set strategy with the difference that it maintains two sets of active constraint: one for active lower bound constraints and another for active upper bound constraints. This way, at each iteration of the optimization, it is known which constraints are likely to be violated and therefore, the optimization can be guided accordingly.

This type of constrained optimization with arbitrary constraints is useful for many application in supply chain. For instance, if a company knows that the actual delivery of a product cannot be higher than a number based on their production capacity or manufacturing constraints, this information can be incorporated in the optimization by setting the upper bound on the predicted values.

In some embodiments, the NNLS optimization can also be solved using the BVLS by setting the lower bound to zero and the upper bound to infinity. However, since the BVLS is computationally slightly slower than NNLS due to maintaining and checking for two sets of constraints at every iteration, the non-negative constrained variant is solved using the NNLS optimization. In fact, the developed solutions of hierarchical forecasting determine the right optimization technique based on the user configuration, so that the user does not require to have any knowledge about the underlying mechanism and optimization.

In summary, methods and systems of hierarchical forecasting disclosed herein eliminate the consistency error completely, while guaranteeing a reduction in the overall forecast error.

FIG. 12 illustrates a flow chart 1200 of a forecast reconciliation in accordance with one embodiment. The notation 1202 of some of the symbols in the flow chart is provided.

At step 1204, summation matrix S, weight matrix W, and base forecast \hat{γ} are input. Summation matrix S is constructed from the hierarchy. Weight matrix W is constructed based on customer preference; it can be constructed prior to the forecasting pipeline. Alternatively, if W includes the base forecasting errors, it is constructed after the forecasting pipeline, since the forecasting pipeline generates the base forecasting errors.

Summation matrix S is an m×n matrix; weight matrix W is an m×m matrix, and \hat{γ} is an m×1 vector, where ‘m’ denotes the total number of nodes in the hierarchy and ‘n’ denotes the total number of nodes in the lowest level of the hierarchy.

At step 1206, initialization of the iteration takes place. Initially, the set of passive constraints Q, an n×1 vector, is set to empty; the candidate solution C is set to zero, as are the reconciled forecasts β (which is an n×1 vector). The set of active constraints R, an n×1 vector, is defined for the ‘n’ lowest nodes in the hierarchy. The error vector ‘e’ is an n×1 vector. components denote the projection error at each of the lowest nodes in the hierarchy. Initially, e=S^{T}W\hat{γ}.

From step 1208 to step 1214, the set of active and passive constraints are computed; at decision 1216, a portion of the solution is tested for negativity. If there is no negativity, then a new iterated error vector e and reconciled forecasts vector β are computed at step 1218. At step 1208, the dual condition of a non-null set of active constraints R, and the maximum error for nodes associated with R are tested. If the test condition in 1008 is not satisfied, then the iterative process ends, with reconciled forecast computed at step 1228. If both conditions, shown in step 1208, are satisfied, then the step 1210 to decision 1216 is repeated.

At decision 1216, if there is negativity in a portion of the candidate solution C_{Q}, step 1220 and step 1222 are performed to remove the negativity; the set of passive constraints Q and the set of active constraints R are updated at step 1224. The candidate solution C is computed, followed by computation of a new iterated error vector e and reconciled forecasts vector β are computed at step 1218. If the test condition at step 1208 is not satisfied, then the iterative process ends, with reconciled forecast computed at step 1228. If both conditions, shown in step 1208, are satisfied, then the step 1210 to decision 1216 is repeated.

The iterative procedure is repeated until the condition set at step 1208 is not satisfied; the reconciled forecast is then computed at step 1228, providing the output at step 1230.

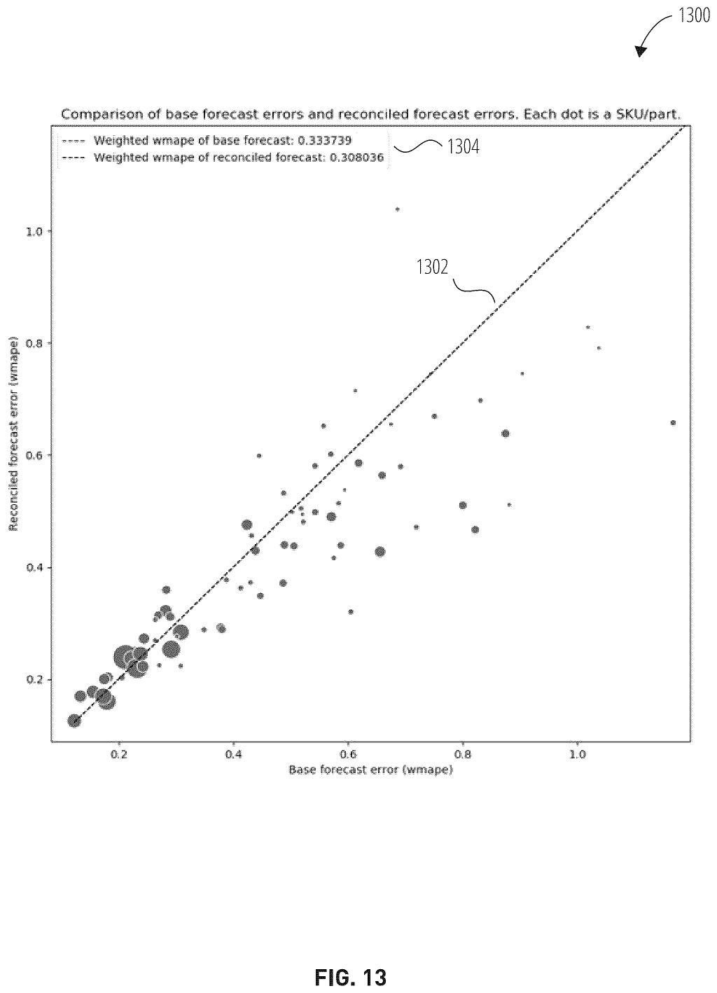

FIG. 13 illustrates a comparison 1300 in accordance with one embodiment, in which reconciled forecast errors are plotted against base forecast errors for different parts/SKUs. This plot and the forecasts are based on real customer data comprising 80 different parts and more than 800 part-customers. Each circle in the plot correspond to a node in the middle level of the hierarchy (i.e. part). The size of each circle is proportionate to the volume of orders in the corresponding node.

Line 1302, with a slope of 1, demarcates where the reconciled forecast error has improved over the base forecast error. The hierarchical forecast reconciliation has improved the forecast accuracy (i.e. reduced the error) for the circles below line 1302 and has decreased the accuracy (i.e. increased the error) for the circles above line 1302. From the graph shown in FIG. 13, the hierarchical reconciliation has improved the majority of forecasts in the hierarchy as most of the circles are below line 1302. This is reflected in item 1304, which shows that the overall forecast error has been reduced from 0.3333739 to 0.308036, which is equivalent to a 7.6% improvement. The forecast error is calculated using Weighted Mean Absolute Percentage Error (WMAPE).

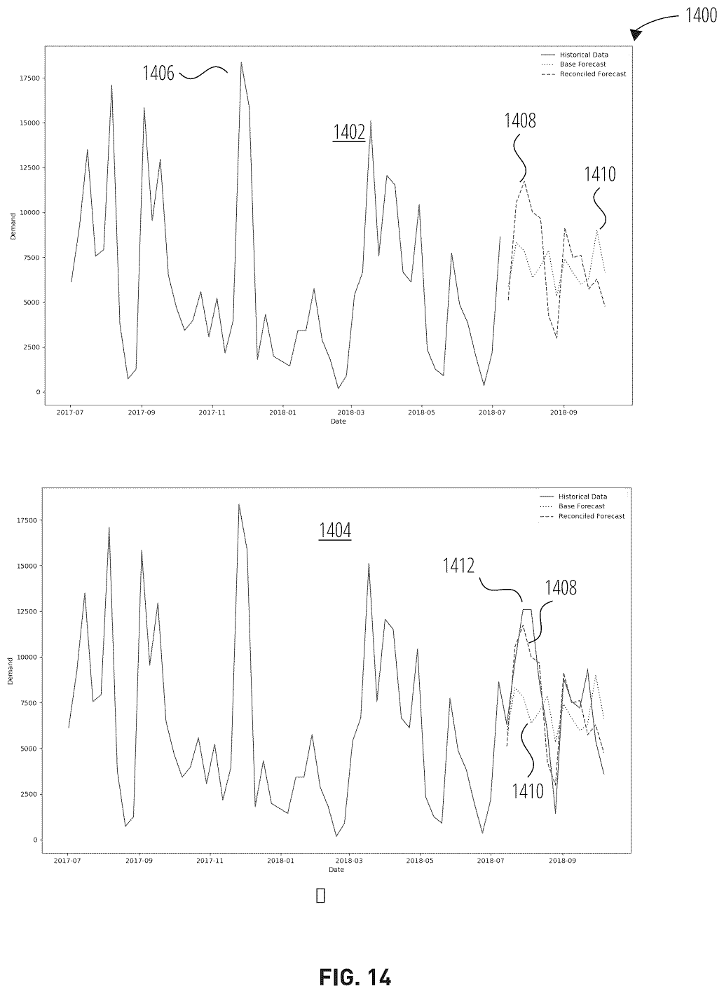

FIG. 14 illustrates two graphs 1400 of demand versus date in accordance with one embodiment.

In graph 1402, historical demand 1406 is shown from July 2017 to July 2018. A pipeline forecasting program (e.g. forecasting pipeline 106 in FIG. 1) is used to provide a reconciled forecast 1408 of the demand from July 2018 onward. A base forecast 1410 is shown from July 2018 onward.

In graph 1404, the actual demand 1412 from July 2018 onward is shown relative to the base forecast 1410 and the reconciled forecast 1408. As evident from the actual demand 1412, the reconciled forecast 1408 is a marked improvement of the predicted demand (from July 2018 onward) than the base forecast 1410 of the demand.

### Multi Hierarchy Solution

Disclosed herein is a system and method where a user can specify multiple hierarchies to be considered at the same time in order to get better accuracy in forecasting. The system and method disclosed herein can train and improve forecasts holistically across all hierarchies.

Consider the dataset shown in Table 1 as an example. It consists of 3 items in 2 different categories, and 3 locations in 2 different distribution centers. In total there are 9 item location combinations (i.e. forecast items or time-series) for which a forecast is required.

TABLE 1

| item_id | location_id | item_category | location_dc |
|---|---|---|---|
| Item1 | Location1 | Category1 | DC1 |
| Item1 | Location2 | Category1 | DC2 |
| Item1 | Location3 | Category1 | DC2 |
| Item2 | Location1 | Category1 | DC1 |
| Item2 | Location2 | Category1 | DC2 |
| Item2 | Location3 | Category1 | DC2 |
| Item3 | Location1 | Category2 | DC1 |
| Item3 | Location2 | Category2 | DC2 |
| Item3 | Location3 | Category2 | DC2 |

An item level hierarchy can be built on the above data like the following:

Levels = [
<>,
<item_category>,
<item_id>,
<item_id, location_id>
]

The first level is the root which is the aggregate sale of all items at all locations. This is the aggregate time-series representing the global sales quantities per day (or week or any temporal bucket).

The second level is the aggregated data at item category level. In this example there are two time-series each representing the total sales of a category across all locations.

The third level is the aggregated data at item level. The time-series at this level is the total sales of each item across all locations.

The fourth and last level is the data at <item_id, location_id> level. This is the lowest level of granularity and it is usually the one that most users are interested in forecasting—that is to forecast the sales of each item at each location separately.

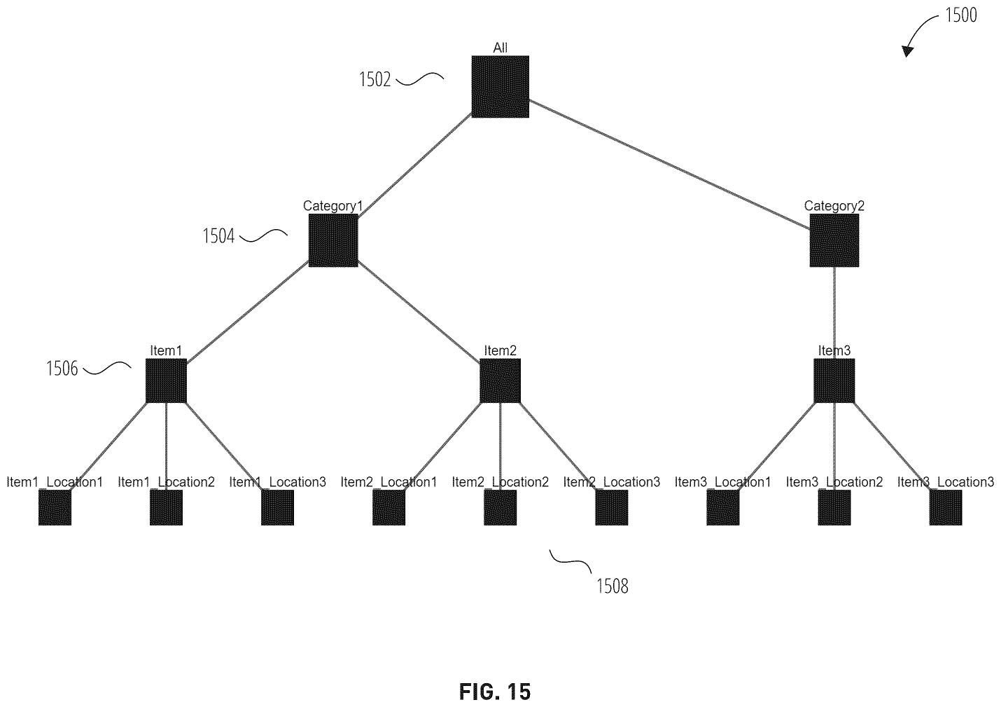

The item hierarchy can be represented by the illustration shown in FIG. 15. In the item hierarchy 1500, the top level 1502 consists of all data (for example, sales). The second level in the item hierarchy 1500 refers to the two categories in Table 1. Category 1 has 2 items (Item 1 and Item 2), while Category 2 has one item (labelled as Item 3).

These three items form the third level 1506 in the item hierarchy 1500. Finally, each item is associated with three locations (Location 1, Location 2 and Location 3). The bottom level 1508 illustrates the nine combinations of the various items and locations.

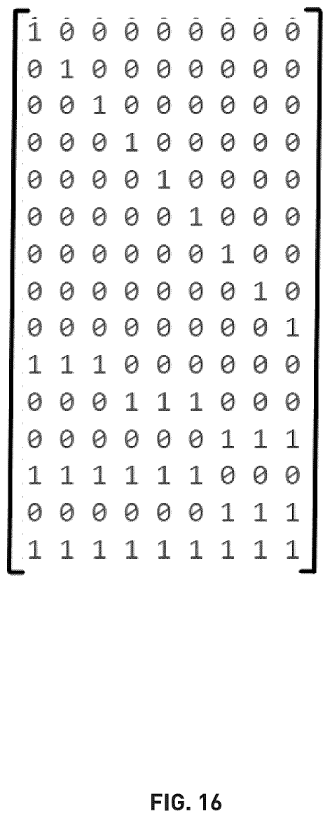

The summation matrix S associated with FIG. 15, is shown in FIG. 16.

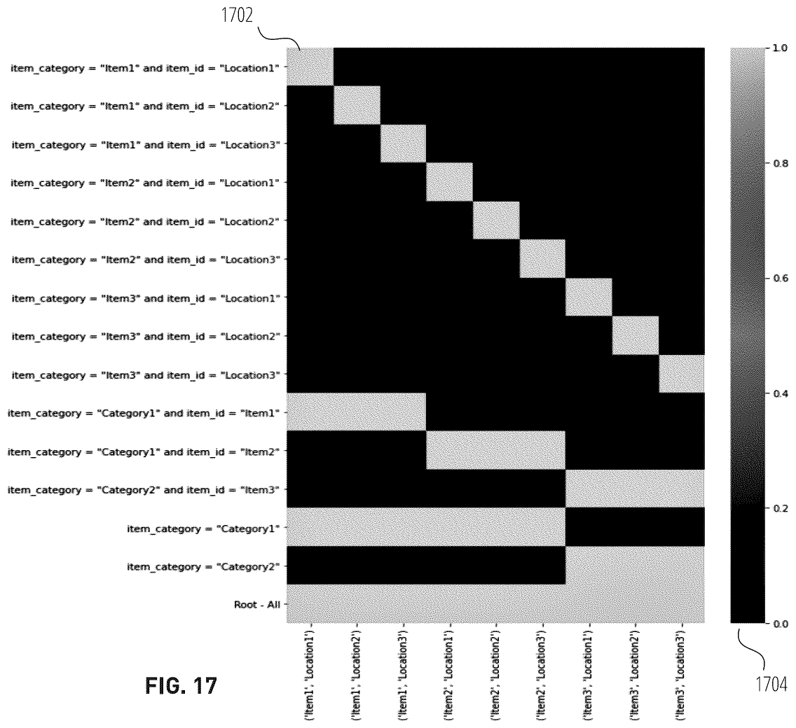

It can also be represented as shown in FIG. 17. Each box 1702 has a value of “1”, while the remaining entries have a value of zero, as shown by the key 1704.

Alternatively, a location level hierarchy can be built on this data like the following:

Levels = [
<>,
<location_dc>,
<location_id>,
<item_id, location_id> ]

The first level is the root which is the aggregate sale of all items at all locations. This is the aggregate time-series representing the global sales quantities per day (or week or any temporal bucket).

The second level is the aggregated data at distribution center level. In this example there are two time-series each representing the total sales of all items for the corresponding distribution center.

The third level is the aggregated data at location level. The time-series at this level is the total sales of all items at each location.

The fourth and last level is the data at <item_id, location_id> level. This is the lowest level of granularity and it is usually the one that most users are interested in forecasting, that is to forecast the sales of each item at each location separately.

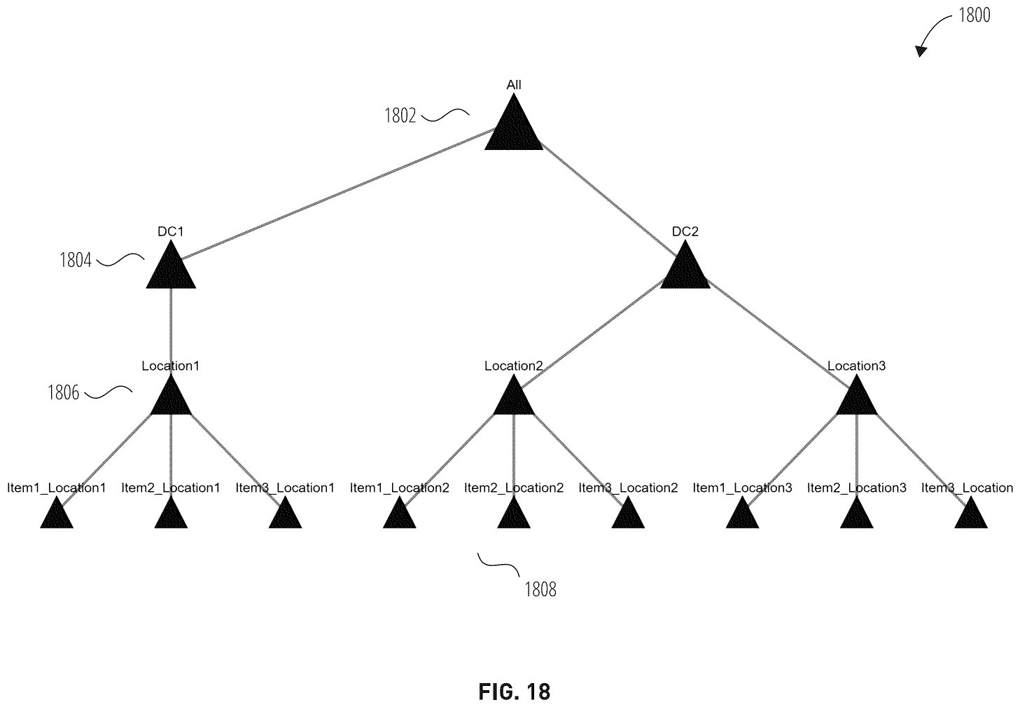

The location hierarchy can be represented by the illustration shown in FIG. 18. In the location hierarchy 1800, the top level 1802 consists of all data (for example, sales). This is identical to all the data in FIG. 15. The second level 1804 in the location hierarchy 1800 refers to the two distribution centers in Table 1. The third level 1806 in the location hierarchy 1800 refers to the three locations in Table 1. Distribution Centre 1 has one location (Location 1), while Distribution Centre 2 has two locations (Location 2 and Location 3). These three items form the third level 1806 in the location hierarchy 1800. Finally, at the fourth level 1808, each location is associated with three items (Item 1, Item 2 and Item 3). The bottom level 1806 illustrates the nine combinations of the various items and locations.

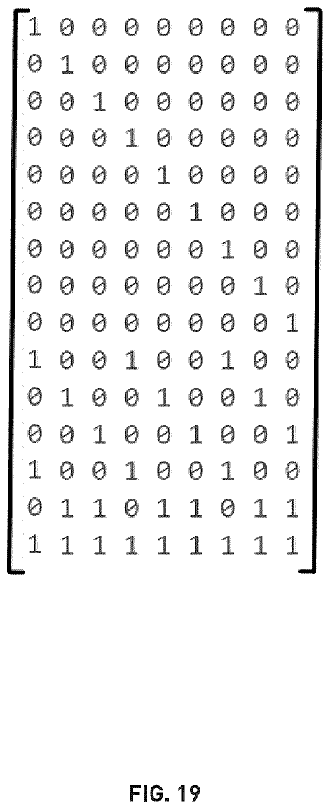

The summation matrix S in this case is shown in FIG. 19.

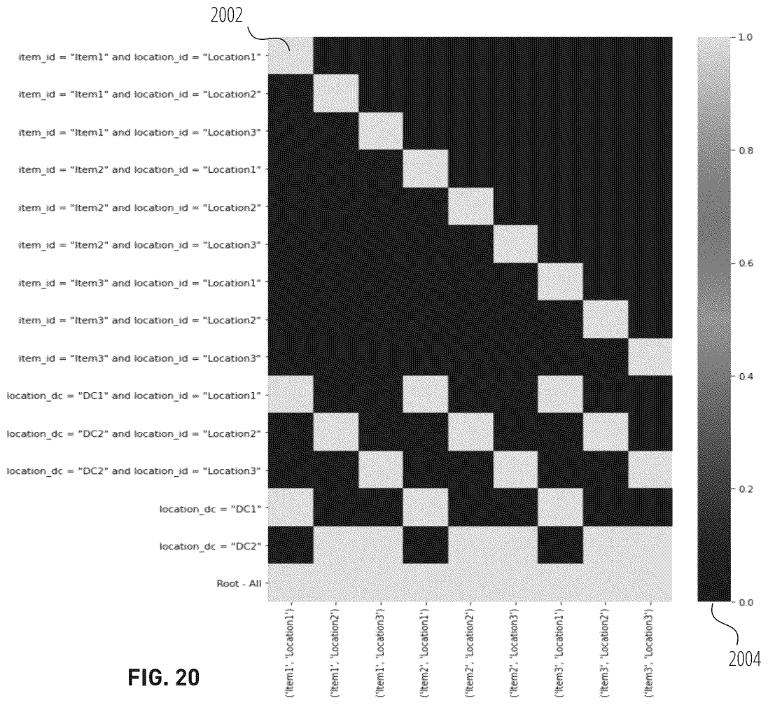

It can also be represented as shown in FIG. 20. Each box 2002 has a value of ‘1’, while the remaining entries have a value of zero, as shown by the key 2004.

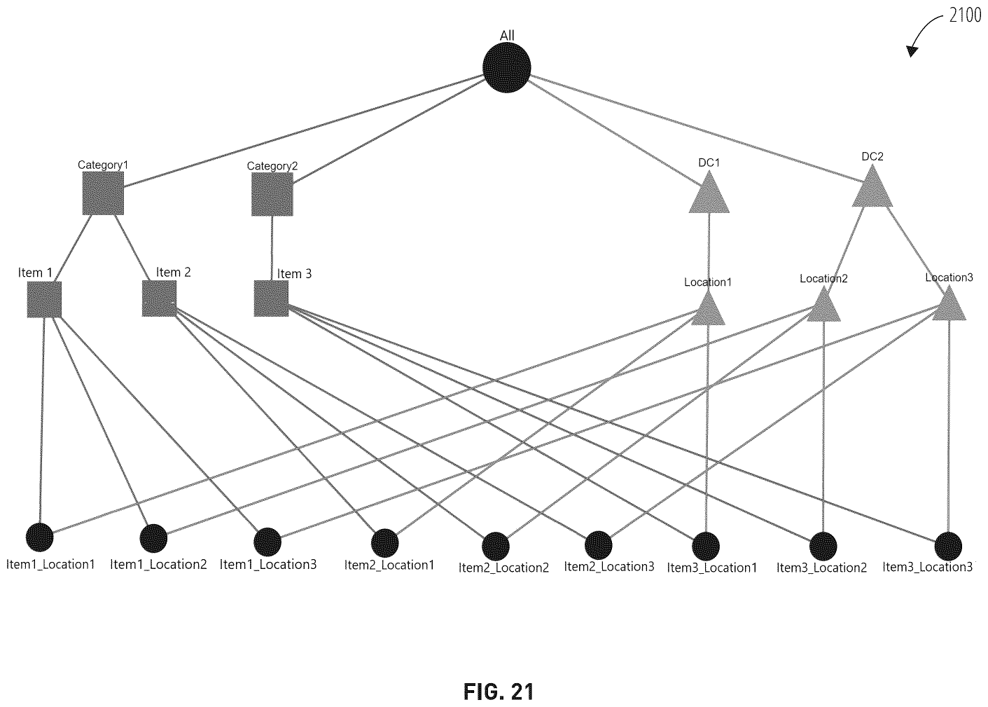

In this case, a multi-hierarchy can be built by combining each of the two hierarchies (item hierarchy 1500 and location hierarchy 1800) and running the forecast reconciliation holistically on the two hierarchies. The multi hierarchy can be represented as shown in FIG. 21.

In the multi-hierarchy 2100, each category, distribution centre, item and location are included.

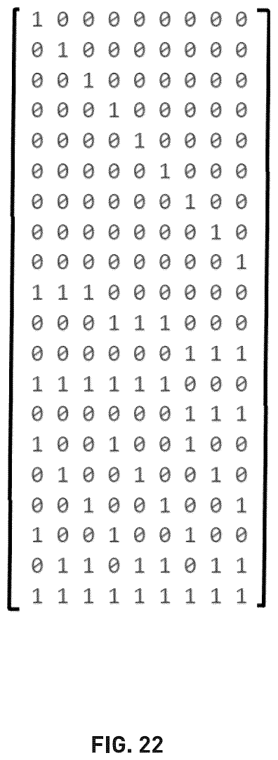

The summation matrix S in this case is shown in FIG. 22.

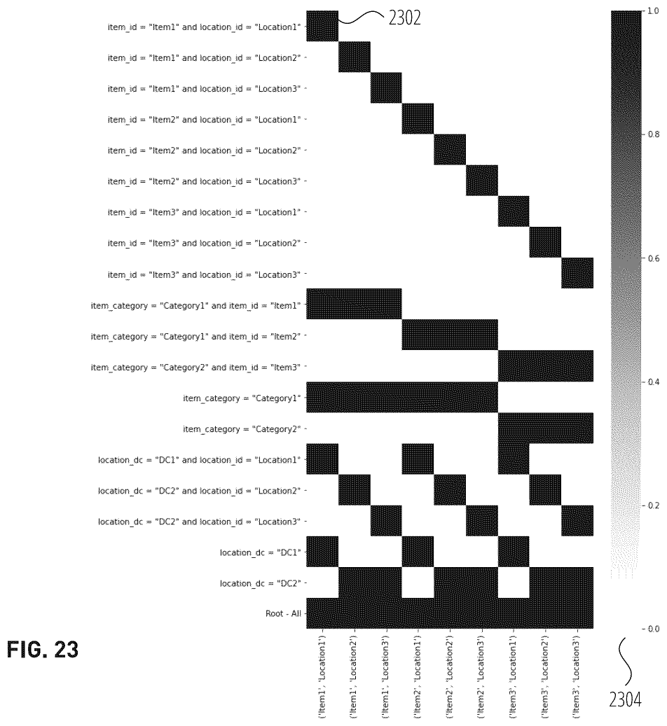

It can also be represented as shown in FIG. 23. Each box 2302 has a value of ‘1’, while the remaining entries have a value of zero, as shown by the key 2304. The steps outlined in FIG. 10-FIG. 12 for hierarchical forecast reconciliation can be used without change for multi-hierarchies in order to get better accuracy.

### Removal of Low Volume and Less Important Items/Nodes

In an example, a medium size retailer has around 20,000 items and 500 locations which results in 10,000,000 timeseries to be forecasted (forecast of each item at each location). A large retailer usually has around 60,000 items and 2,000 locations resulting in 120,000,000 timeseries to be forecasted. Quick Service Restaurants (QSR) also have large number of item-locations to forecast. Fast food chains have fewer items (˜1,000) but more locations (˜15,000) which results in the same scale requirements as mid-size retailer.

Running any hierarchical forecast reconciliation algorithm on large datasets that include hundreds of thousands of forecast items is computationally impossible. For a 10,000,000 time-series, the size of the summation matrix is around 10,500,000×10,000,000 which has more than 100 trillion elements. Dealing with matrices of that size is impossible both memory-wise and also compute-wise. Solving the optimization in closed form is impossible with data of that size.

Even though retailers have a lot of items on their shelves, not all items sell frequently. The majority of the items have intermittent sales and are very sparse with many “zero” sale days. Many of the items are also not so important in terms of sale prediction, either because retailers have lower margin on those items, or lower cost, and in general they represent a tiny portion of their business in terms of dollar value and revenue. So, the scope of the problem can be reduced based on the following factors:
Volume of sales, lower volumes are less important.
Frequency of sales, how sparse the sales are, fraction of 0 sales to the total. Sparse items are less important.
Profit margin on the items, lower margin items are less important.
Cost of items (inventory cost for retailers, manufacturing cost for manufacturing companies, perishable vs non-perishable items for QSR), lower cost items are less important.
Revenue share, a combination of cost, margin, and sales volume. Items that represent a small portion of the revenue are less important.

Therefore, not all the items in a hierarchical reconciliation algorithm are used—in order to improve the runtime of procedure described in FIG. 10-FIG. 12 and make it feasible. For items, the memory requirement for the matrices is quadratic, while compute time required for the reconciliation algorithm is cubic. Therefore, reducing the number of items can have a quadratic reduction in the size of the summation matrix, therefore resulting in a quadratic reduction in memory requirement. It also has cubic reduction in the compute time required to solve the optimization in closed form—thereby reducing the computation time for processing. For instance, reducing the number of items in the hierarchical reconciliation algorithm by a factor of ten, reduces memory requirement by a factor of 100, and reduces the computational rime needed by a factor of 1000. In practice, the reduction in compute time may be a bit less than cubic because of parallelization inefficiencies and overheads. In some embodiments, the methods and systems disclosed herein can be applied where the summation matrix used in the multiple hierarchies is at most of the order (100000×100000).

The scope of the problem can be reduced objectively. In general, accuracy of predictions for sparse and intermittent sales are lower. Therefore, it is better to exclude them from the reconciliation process so that they do not degrade the quality of other forecasts. Here are some objective measures that can be used to filter out items and reduce the scope of the problem:

Removal of items where the sales is 0 in more than x % of time periods (for example, more than 40% sparse).

Removal of items where the average sales volume is smaller than ‘×’ units per day.

Removal of items where the accuracy is below x % (e.g. 50%) on the validation set used in the machine learning-based forecast.

Removal of items that have more than x % (for example, 25%) over-forecast or more than x % under-forecast on the validation set used in the machine learning-based forecast.

Usually 5%-10% is a good threshold for the number of important items for retailers and fast food chains (QSRs). With 95% reduction in the number of items (that is, 5% of the items are maintained in the multi-level hierarchy), the result is up to 8,000 times speedup in the runtime of the algorithm.

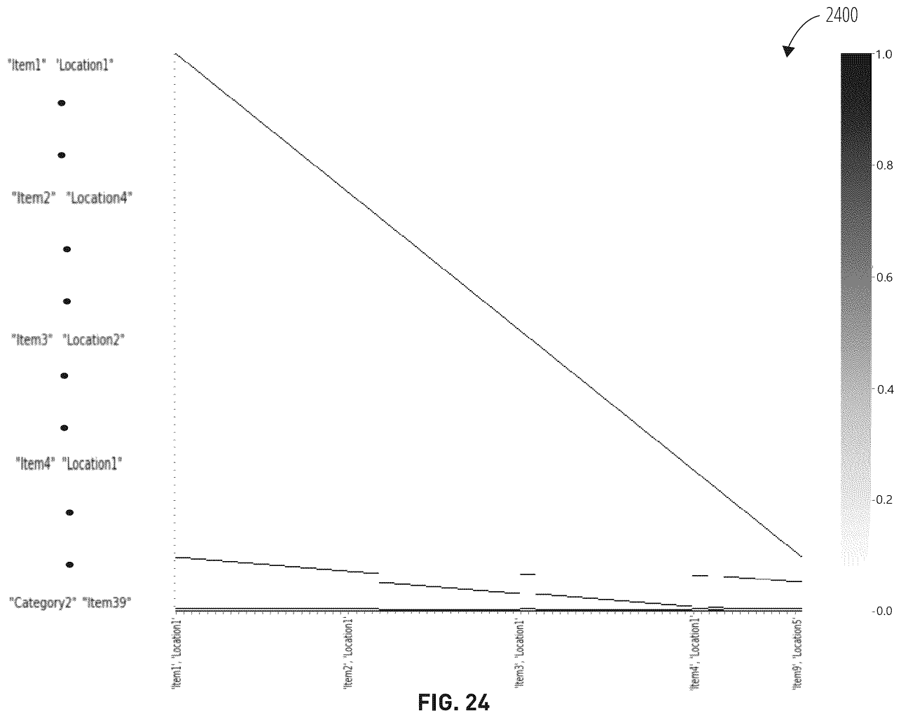

FIG. 24 illustrates a heat map 2400 that represents the summation matrix for 40 items (in 5 categories) at 40 locations (in 5 distribution centers) which results in 1,600 timeseries. The size of the matrix is <1646×1600> (2,633,600 entries).

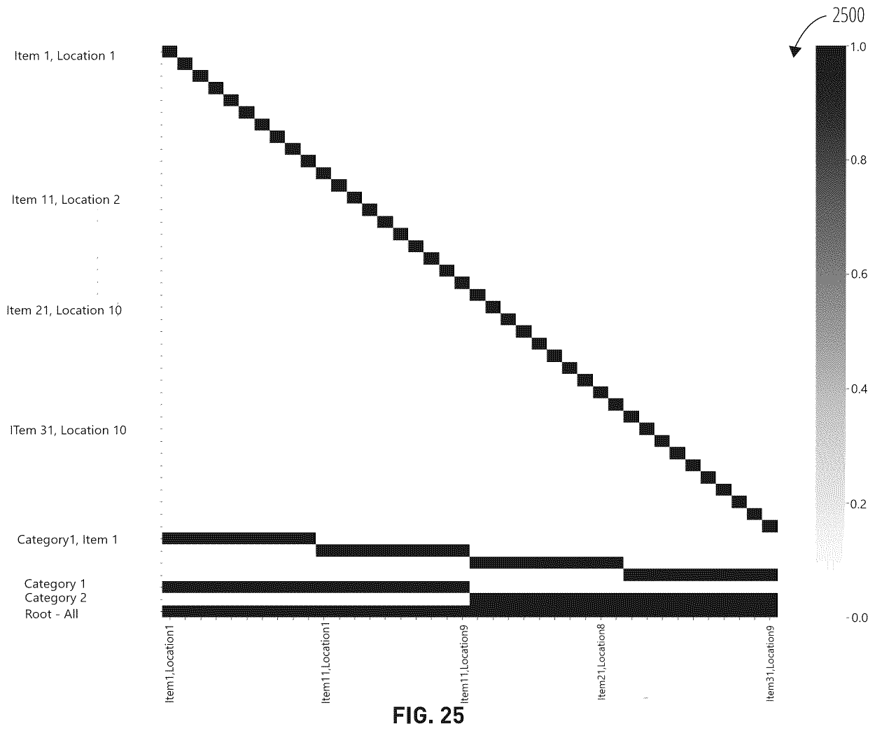

Reducing the number of items by a factor of 10, to 4 items in 40 locations reduces the size to <169×160> (27,040 entries). FIG. 25 illustrates the truncated heat map 2500.

This was tested on a realistic use-case with customer data consisting of 200 items (in 10 categories) and 200 locations (in 10 distribution centers). This results in 40,000 timeseries to be forecasted. The size of the summation matrix is <40211×40000> and it took 572.888912 seconds to run the forecast reconciliation algorithm on a Standard_D96a_v4 Azure instance which has 96 CPU cores and 384 GB memory. By taking the top 10% of items and reducing the number of items to 20, the number of timeseries becomes 4,000. After removing low importance nodes, the size of the matrix became <4031×4000> and it took 1.157279 seconds to run on the same machine which is 495.03x speedup. The same speedup rates holds true for datasets of different sizes.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a processor, data related to two or more hierarchies;
generating, by the processor, a multi-level hierarchy based on the data, the two or more hierarchies and a summation matrix related to a structure of the multi-level hierarchy;
truncating, by the processor, the multi-level hierarchy such that the summation matrix is reduced to a maximum size of order (100000×100000);
receiving, by the processor, a base forecast of the hierarchy;
generating, by the processor, a weight matrix, the weight matrix reflecting a weight for each node of the multi-level hierarchy; and
generating, by the processor, a reconciled forecast based on a projection of the base forecast onto a bottom level of the multi-level hierarchy, subject to a constraint on each node of the bottom level of the multi-level hierarchy.

2. The computer-implemented method of claim 1, wherein the base forecast is generated from a non-linear Machine Learning model.

3. The computer-implemented method of claim 1, wherein truncation of the summation matrix is based on one or more threshold conditions applied to the data.

4. The computer-implemented method of claim 1, wherein the reconciled forecast is based on a non-negative least squares optimization technique.

5. The computer-implemented method of claim 1, wherein the reconciled forecast is based on an iterative optimization in which each node of the bottom level forecast is bound within a respective range.

6. The computer-implemented method of claim 1, wherein each entry of the weight matrix is related to one or more metrics of the multi-level hierarchy.

7. The computer-implemented method of claim 1, wherein each entry of the weight matrix is related to a forecast error of each node of the multi-level hierarchy, the forecast error obtained from a validation set used in training a non-linear machine learning model used for generating the base forecast.

8. A computing apparatus, the computing apparatus comprising:
a processor; and
a memory storing instructions that, when executed by the processor, configure the apparatus to:
receive data related to two or more hierarchies;
generate a multi-level hierarchy based on the data, the two or more hierarchies and a summation matrix related to a structure of the multi-level hierarchy;
truncate the multi-level hierarch such that the summation matrix is reduced to a maximum size of order (100000×100000);
receive a base forecast of the hierarchy;
generate a weight matrix, the weight matrix reflecting a weight for each node of the multi-level hierarchy; and
generate a reconciled forecast based on a projection of the base forecast onto a bottom level of the multi-level hierarchy, subject to a constraint on each node of the bottom level of the multi-level hierarchy.

9. The computing apparatus of claim 8, wherein the base forecast is generated from a non-linear Machine Learning model.

10. The computing apparatus of claim 8, wherein truncation of the summation matrix is based on one or more threshold conditions applied to the data.

11. The computing apparatus of claim 8, wherein the reconciled forecast is based on a non-negative least squares optimization technique.

12. The computing apparatus of claim 8, wherein the reconciled forecast is based on an iterative optimization in which each node of the bottom level forecast is bound within a respective range.

13. The computing apparatus of claim 8, wherein each entry of the weight matrix is related to one or more metrics of the multi-level hierarchy.

14. The computing apparatus of claim 8, wherein each entry of the weight matrix is related to a forecast error of each node of the multi-level hierarchy, the forecast error obtained from a validation set used in training a non-linear machine learning model used for generating the base forecast.

15. A non-transitory computer-readable storage medium, the computer-readable storage medium including instructions that when executed by a computer, cause the computer to:
receive data related to two or more hierarchies;
generate a multi-level hierarchy based on the data, the two or more hierarchies and a summation matrix related to a structure of the multi-level hierarchy;
truncate the multi-level hierarch such that the summation matrix is reduced to a maximum size of order (100000×100000);
receive a base forecast of the hierarchy;
generate a weight matrix, the weight matrix reflecting a weight for each node of the multi-level hierarchy; and
generate a reconciled forecast based on a projection of the base forecast onto a bottom level of the multi-level hierarchy, subject to a constraint on each node of the bottom level of the multi-level hierarchy.

16. The computer-readable storage medium of claim 15, wherein the base forecast is generated from a non-linear Machine Learning model.

17. The computer-readable storage medium of claim 15, wherein truncation of the summation matrix is based on one or more threshold conditions applied to the data.

18. The computer-readable storage medium of claim 15, wherein the reconciled forecast is based on a non-negative least squares optimization technique.

19. The computer-readable storage medium of claim 15, wherein the reconciled forecast is based on an iterative optimization in which each node of the bottom level forecast is bound within a respective range.

20. The computer-readable storage medium of claim 15, wherein each entry of the weight matrix is related to one or more metrics of the multi-level hierarchy.

21. The computer-readable storage medium of claim 15, wherein each entry of the weight matrix is related to a forecast error of each node of the multi-level hierarchy, the forecast error obtained from a validation set used in training a non-linear machine learning model used for generating the base forecast.
